(19) United States
(12) Patent Application Publication
(10) Pub. No.: US 2020/0306678 A1
(43) Pub. Date: Oct. 1, 2020

(54) ELECTRONIC APPARATUS

(71) Applicant: FUJITSU CLIENT COMPUTING LIMITED, Kanagawa (JP)

(72) Inventors: Yoshihiko Kanno, Kawasaki (JP); Ikki Tatsukami, Kawasaki (JP); Ryohei Sato, Kawasaki (JP)

(73) Assignee: FUJITSU CLIENT COMPUTING LIMITED, Kanagawa (JP)

(21) Appl. No.: 16/790,265

(22) Filed: Feb. 13, 2020

(30) Foreign Application Priority Data
Mar. 26, 2019 (JP) 2019-058786

(51) Int. Cl. B01D 46/00; G06F 1/18

(52) U.S. Cl. CPC B01D 46/0023; B01D 2267/40; B01D 2279/45; G06F 1/182

(57) ABSTRACT

An electronic apparatus includes a housing, a first filter, and a second filter. The housing includes a first intake port. The first filter is disposed on an outer side of the housing and covers the first intake port. The second filter includes a first part coarser than the first filter and covers the first filter from a side opposite to the first intake port.

### CROSS-REFERENCE TO RELATED APPLICATIONS

This application is based upon and claims the benefit of priority from Japanese Patent Application No. 2019-058786, filed Mar. 26, 2019, the entire contents of which are incorporated herein by reference.

### FIELD

The present disclosure relates generally to an electronic apparatus.

### BACKGROUND

Conventionally, there is known an electronic apparatus including a housing provided with an intake port and a filter device provided in the housing and covering the intake port.

### SUMMARY

An electronic apparatus includes a housing, a first filter, and a second filter. The housing is provided with a first intake port. The first filter is provided on an outer side of the housing and covers the first intake port. The second filter includes a first part coarser than the first filter and covers the first filter from a side opposite to the first intake port.

### BRIEF DESCRIPTION OF THE DRAWINGS

FIG. 1 is an exemplary exploded perspective view of an electronic apparatus according to an embodiment;

FIG. 2 is an exemplary plan view of a second filter of the electronic apparatus according to the embodiment;

FIG. 3 is an exemplary front view of a housing and a cover member of the electronic apparatus according to the embodiment;

FIG. 4 is an exemplary plan view of a second filter of an electronic apparatus according to a first modification; and

FIG. 5 is an exemplary plan view of a second filter of an electronic apparatus according to a second modification.

### DETAILED DESCRIPTION

The following will disclose exemplary embodiments and modifications of the invention. The configurations of the embodiments and modifications described in the following, and the actions and effects of the configurations are examples. The invention may be achieved by configurations other than the embodiments and modifications disclosed in the following. Moreover, in the invention, it is possible to obtain at least one of various effects (including derivative effects) obtained by the configurations.

Furthermore, the embodiments and modifications disclosed in the following include same components. Therefore, in the following, the same components will be represented with same symbols, and the repeated explanation will be omitted. Note that in the specification, ordinal numbers are used to distinguish parts, members, regions, positions, directions, and the like, and do not indicate the order or priority.

### Embodiment

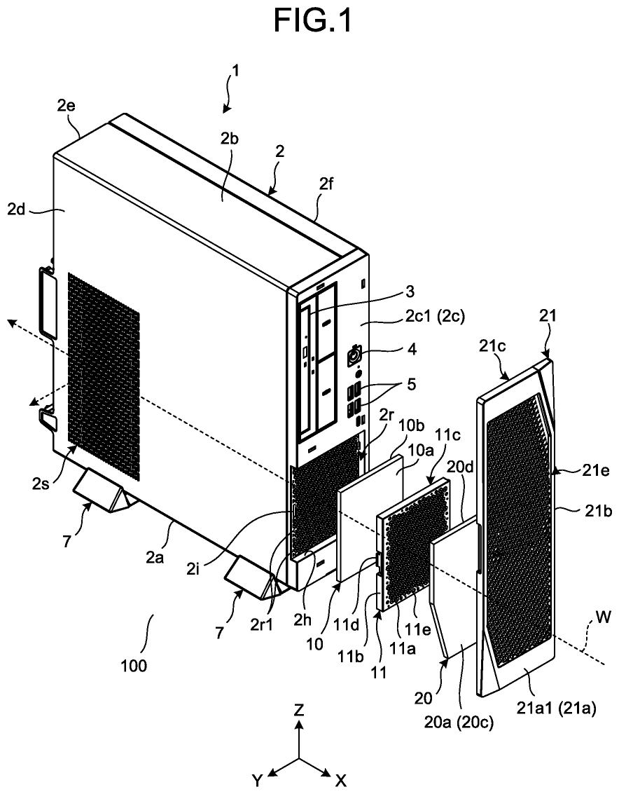

FIG. 1 is an exploded perspective view of an electronic apparatus 1 according to an embodiment. As illustrated in FIG. 1, the electronic apparatus 1 includes, for example, a housing 2, a main filter 10, a main filter cover 11, a prefilter 20, and a prefilter cover 21. The electronic apparatus 1 is configured as a desktop industrial computer (FA personal computer), for example, and may be used in the state where the prefilter cover 21 covers (closes) a front wall 2c of the housing 2.

Note that in the following description, three directions orthogonal to one another are defined for the convenience. The X direction is along a depth direction (front-rear direction) of the housing 2, and is along a thickness direction of the main filter 10 and the prefilter 20. The Y direction is along a width direction (right and left direction) of the housing 2, and is along a horizontal width direction of the main filter 10 and the prefilter 20. The Z direction is along a height direction (up and low direction) of the housing 2, and is along a vertical width direction of the main filter 10 and the prefilter 20. Moreover, in the following description, the X direction may be also referred to as a front side, the opposite direction of the X direction as a rear side, the Y direction as a left side, the opposite direction of the Y direction as a right side, the Z direction as an upper side, and the opposite direction of the Z direction as a lower side.

As illustrated in FIG. 1, the housing 2 is configured in a box shape to be flat rectangular parallelepiped in the Y direction, for example. The housing 2 includes a plurality of wall portions such as a bottom wall 2a, a top wall 2b, a front wall 2c, a left wall 2d, a rear wall 2e, and a right wall 2f. The bottom wall 2a is also referred to as a lower wall, and the top wall 2b is also referred to as an upper wall. Moreover, the front wall 2c, the left wall 2d, the rear wall 2e, and the right wall 2f are also referred to as a side wall, a peripheral wall, or the like.

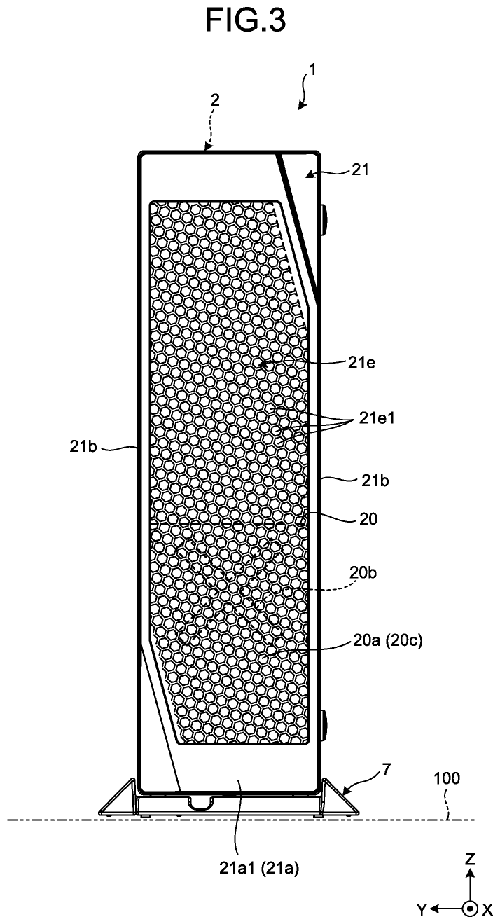

Both the bottom wall 2a and the top wall 2b extend along the direction orthogonal to the Z direction (XY-plane), and are provided in parallel to each other with an interval in the Z direction. The bottom wall 2a forms a lower end portion of the housing 2, and the top wall 2b forms an upper end portion of the housing 2. The housing 2 is placed and supported vertically by a stand device 7 interposed between the bottom wall 2a and an installation surface 100 such as a table, a stand, and a shelf (see FIGS. 1 and 3).

As illustrated in FIG. 1, both the left wall 2d and the right wall 2f extend along the direction orthogonal to the Y direction (XZ-plane), and are provided in parallel to each other with an interval in the Y direction. The left wall 2d extends between end portions in the Y direction of the bottom wall 2a and the top wall 2b, and the right wall 2f extends between end portions in the opposite direction of the Y direction of the bottom wall 2a and the top wall 2b. The left wall 2d forms a left end portion of the housing 2, and the right wall 2f forms a right end portion of the housing 2.

Moreover, each of the left wall 2d and the rear wall 2e has a discharge port 2s. The discharge port 2s is formed as a part where a plurality of small holes penetrating the left wall 2d and the rear wall 2e are gathered, for example. The discharge port 2s is able to discharge an air flow W, which has been subjected to heat exchange with a heat generating part in the housing 2 by a cooling fan or the like (not illustrated), to the outside of the housing 2.

Both the front wall 2c and the rear wall 2e extend along the direction orthogonal to the X direction (YZ-plane), and are provided in parallel to each other with an interval in the X direction. The front wall 2c extends between end portions in the X direction of the bottom wall 2a and the top wall 2b, and the rear wall 2e extends between end portions in the opposite direction of the X direction of the bottom wall 2a and the top wall 2b. The front wall 2c forms a front end portion of the housing 2, and the rear wall 2e forms a rear end portion of the housing 2. The front wall 2c is provided with an optical drive 3, a power button 4, connectors 5, and the like.

Moreover, the front wall 2c is provided with a concave portion 2h. The concave portion 2h is recessed to the opposite direction of the X direction from a front surface 2c1 in the X direction of the front wall 2c. The main filter cover 11 and the main filter 10 are integrally stored in the concave portion 2h. The concave portion 2h is positioned, on the front surface 2c1, deviating in the opposite direction of the Z direction from the optical drive 3, the power button 4, the connectors 5, and the like.

Moreover, an intake port 2r is provided on a bottom part of the concave portion 2h. The intake port 2r is formed as a part where a plurality of small holes 2r1 penetrating the bottom part of the concave portion 2h in the X direction are gathered. The intake port 2r is able to introduce an air flow W from which dusts in air have been removed by the prefilter 20, the main filter 10, and the like, into the housing 2. The prefilter 20 and the main filter 10 will be described later. The intake port 2r is an example of the first intake port.

The main filter 10 is formed as a dustproof filter with a given size of mesh collecting dusts in air, for example. The main filter 10 has a front surface 10a in the X direction and a rear surface 10b in the opposite direction of the X direction. The front surface 10a faces the main filter cover 11, and the rear surface 10b faces the intake port 2r. The main filter 10 is an example of the first filter, and the front surface 10a is an example of the first surface.

The main filter 10 is formed in a square plate shape extending along the bottom part of the concave portion 2h. In the embodiment, the size of the main filter 10 is set to be substantially the same as the size of the bottom part of the concave portion 2h. In this manner, the substantially whole area of the intake port 2r is covered by the rear surface 10b of the main filter 10. The main filter 10 is made of a resin material such as polyurethane, for example.

The main filter cover 11 has, for example, a bottom wall 11a and a peripheral wall 11b provided in the peripheral part of the bottom wall 11a. The main filter cover 11 has a concave portion 11c that is surrounded by the bottom wall 11a and the peripheral wall lib and is open to the opposite direction of the X direction. The concave portion 11c houses the main filter 10. The main filter 10 is fixed (held) in the concave portion 11c by a connecting tool, a hook part, or a tape, for example.

Moreover, the main filter cover 11 includes a hook part 11d, and the bottom part of the concave portion 2h has an opening 2i through which the hook part 11d passes. The main filter cover 11 and the front wall 2c (housing 2) are connected to be removable from each other by so-called snap-fit of engagement between a claw of the hook part 11d and an edge portion of the opening 2i.

Moreover, the bottom wall 11a has a vent hole 11e. The vent hole 11e is formed as a part where a plurality of small holes penetrating the bottom wall 11a in the X direction are gathered, for example. The vent hole 11e is positioned between the main filter 10 and the prefilter 20, and overlaps (arranged together with) the intake port 2r and an intake port 21e of the prefilter cover 21 in the X direction.

The prefilter 20 is positioned in the X direction from the main filter 10, that is, on the side opposite to the intake port 2r. The prefilter 20 is formed as a dustproof filter with a given size of mesh collecting dusts in air, for example, and has a larger numerical aperture than the main filter 10. The prefilter 20 has a front surface 20c in the X direction and a rear surface 20d in the opposite direction of the X direction. The front surface 20c faces the prefilter cover 21, and the rear surface 20d faces the main filter cover 11. The prefilter 20 is an example of the second filter.

The prefilter 20 is formed in a square plate shape extending along the main filter 10. In the embodiment, the size of the prefilter 20 is set to be larger than the size of the bottom wall 11a, that is, the size of the front surface 10a of the main filter 10. In this manner, the substantially whole area of the front surface 10a is covered by the prefilter 20 through the bottom wall 11a. The prefilter 20 is made of a resin material such as polyurethane, for example. Note that the prefilter 20 may be made of a material different from the material of the main filter 10.

The prefilter cover 21 has, for example, a bottom wall 21a and a peripheral wall 21b provided in the peripheral part of the bottom wall 21a. The prefilter cover 21 has a concave portion 21c that is surrounded by the bottom wall 21a and the peripheral wall 21b and is open to the opposite direction of the X direction. The concave portion 21c houses the prefilter 20. The prefilter 20 is fixed (held) in the concave portion 21c by a connecting tool, a hook part, or a tape, for example.

Moreover, the prefilter cover 21 has a catch portion (not illustrated) caught by the front wall 2c in the X direction. Similarly to the main filter cover 11, the prefilter cover 21 is connected to the front wall 2c (housing 2) to be removable by so-called snap-fit by catch of a claw of the catch portion. Note that the prefilter cover 21 is not limited to this example, and may be connected to the front wall 2c to be rotatable (opened and closed) through a hinge having a rotation center extending in the Z direction.

Moreover, the bottom wall 21a has the intake port 21e. The intake port 21e is formed as a part where a plurality of small holes 21e1 (see FIG. 3) penetrating the bottom wall 21a in the X direction are gathered, for example. In the embodiment, the size of the intake port 21e (opening area) is set to be larger than the size of the prefilter 20. The intake port 21e is an example of the second intake port. The small holes 21e1 are also referred to as a honeycomb structure or the like.

The prefilter cover 21 is not limited to this example. For example, the prefilter cover 21 may be configured to have substantially the same size as the prefilter 20, and the optical drive 3 (see FIG. 1), the power button 4, the connectors 5, and the like may be exposed in the X direction.

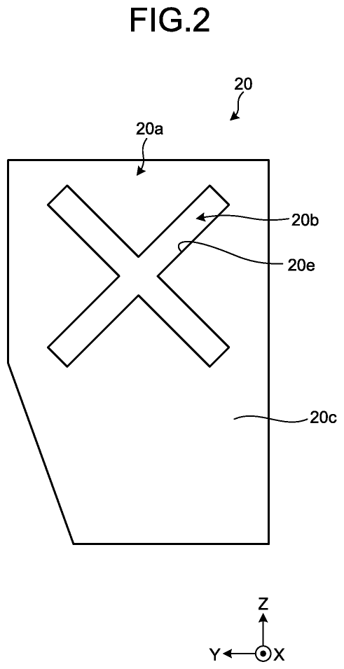

FIG. 2 is a plan view of the prefilter 20. As illustrated in FIG. 2, the prefilter 20 includes, for example, a first part 20a and a second part 20b. The second part 20b is a part positioned in the substantially center part of the prefilter 20, and covers a part of the main filter 10. The first part 20a is a part positioned in the peripheral part of the second part 20b, and covers at least a part of the main filter 10 (see FIG. 1). Note that in FIG. 1, the illustration of the second part 20b is omitted for convenience.

As illustrated in FIG. 2, the first part 20a has a slit-formed opening 20e penetrating the front surface 20c and the rear surface 20d in the X direction. The opening 20e is formed to be substantially X-shaped from the view in the X direction. The first part 20a is formed by a filter with a coarseness (mesh size) of about 1.2 to 2 times that of the main filter 10, for example. The first part 20a is also referred to as the third filter or the like.

The second part 20b is integrated to the first part 20a by engagement with or fitting in the opening 20e, for example. The second part 20b is substantially X-shaped along the opening 20e from the view in the X direction. The second part 20b is exposed to both sides in the X direction of the prefilter 20, and forms, together with the first part 20a, a part of the front surface 20c and the rear surface 20d. Then, in the embodiment, the second part 20b is formed by a filter with a coarseness (mesh size) equivalent to the main filter 10. The second part 20b is also referred to as the fourth filter or the like.

FIG. 3 is a front view of the housing 2 and the prefilter cover 21 of the electronic apparatus 1. As illustrated in FIG. 3, in the embodiment, the front surface 20c of the prefilter 20 is exposed, through the intake port 21e, to the X direction of the prefilter cover 21, that is, the side opposite to the main filter 10.

The prefilter 20 is able to collect, with the first part 20a, dusts larger than the coarseness of the first part 20a, and collect, with the second part 20b, dusts larger than the coarseness of the second part 20b. In the embodiment, the coarseness of the first part 20a and the coarseness of the second part 20b are different from each other. Thus, when fine dusts are collected by the second part 20b, the dusts emerge in the substantially X shape along the second part 20b.

Here, the clogging state (degree) of the second part 20b is substantially the same as that of the area of the main filter 10 positioned in the periphery part of the second part 20b from the view in the X direction, that is, the area of the main filter 10 not overlapping the second part 20b in the X direction. This allows an operator to easily confirm the clogging state of the main filter 10 hidden behind the prefilter 20 by confirming the clogging state of the second part 20b through the intake port 21e. That is, the second part 20b functions as an indicator showing the clogging state of the main filter 10.

Moreover, in the embodiment, the second part 20b is formed in the similar color to the first part 20a and a front surface 21a1 in the X direction of the prefilter cover 21. The color of the second part 20b may be appropriately set among various colors such as black, grey, and white. Note that the color of the second part 20b is preferably set to a color different from the color of dusts to be collected, so that the dusts are conspicuous. The front surface 21a1 is an example of the second surface.

As described above, in the embodiment, the electronic apparatus 1 includes the housing 2 provided with the intake port 2r (first intake port), the main filter 10 (first filter) provided on the outer side of the housing 2 and covering the intake port 2r, and the prefilter 20 (second filter) having the first part 20a coarser than the main filter 10 and covering the main filter 10 from the side opposite to the intake port 2r (X direction).

In such a configuration, the prefilter 20 is able to collect larger dusts than the coarseness (mesh size) of the first part 20a, which makes it possible to prevent clogging of the main filter 10 due to the dusts, for example. Therefore, it is possible, for example, to easily extend the lifetime of the main filter 10 and easily reduce the frequency of replacing the main filter 10 to reduce efforts for maintenance operation.

Moreover, in the embodiment, the prefilter 20 is larger in size than the front surface 10a (first surface) on the prefilter 20 side, or closer to the prefilter 20, of the main filter 10.

In such a configuration, the prefilter 20 easily covers the substantially whole area of the front surface 10a, and further prevents clogging of the main filter 10, for example.

In the embodiment, the prefilter 20 includes the second part 20b with a coarseness equivalent to the main filter 10.

In such a configuration, the prefilter 20 is able to collect larger dusts than the coarseness (mesh size) of the second part 20b, which makes it possible to prevent clogging of the main filter 10 due to the dusts, for example.

Moreover, in the embodiment, the electronic apparatus 1 includes the prefilter cover 21 (cover member) having the intake port 21e (second intake port) overlapping the intake port 2r in the X direction and covering the prefilter 20 from the side opposite to the main filter 10, and the second part 20b is exposed to the side opposite to the main filter 10 (X direction) through the intake port 21e.

Such a configuration allows an operator to easily confirm the clogging state of the main filter 10 hidden on the housing 2 side than the prefilter 20 by confirming the clogging state (degree) of the second part 20b through the intake port 21e, for example. Therefore, it is possible to further reduce efforts for maintenance operation of the main filter 10, for example.

In the embodiment, the second part 20b has the similar color to the first part 20a and the front surface 21a1 (second surface) on the side opposite to the prefilter 20 of the prefilter cover 21.

In such a configuration, the dusts collected by the second part 20b are more conspicuous, and thus it is possible to confirm more easily the clogging state (degree) of the second part 20b and the main filter 10, for example.

First Modification

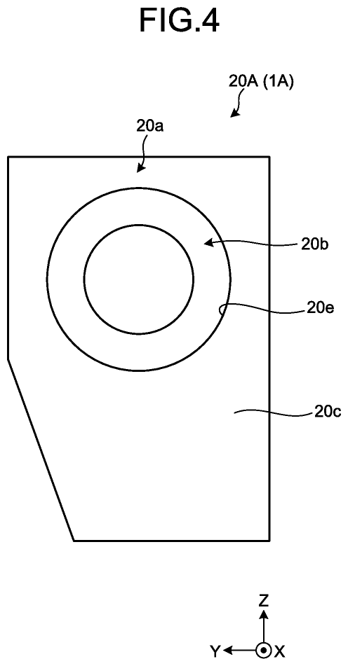

FIG. 4 is a plan view illustrating a prefilter 20A of an electronic apparatus 1A according to the first modification. The electronic apparatus 1A has the same configuration as the electronic apparatus 1 of the above-described embodiment. Thus, the electronic apparatus 1A obtains the same actions and effects based on the same configuration as the above-described embodiment.

However, the first modification is different from the above-described embodiment in the aspect that the second part 20b of the prefilter 20A has a ring shape (annular shape), as illustrated in FIG. 4. The second part 20b is integrated to the first part 20a by engagement with or fitting in the ring-shaped opening 20e, for example.

Then, in the first modification, the second part 20b is formed by a filter with a coarseness (mesh size) less than the main filter 10 (see FIG. 1), for example. The second part 20b is also referred to as the fifth filter or the like.

Therefore, in the first modification, the clogging state (degree) is confirmed using the second part 20b, which prevents more securely the use of the main filter 10 in the clogged state (state exceeding the critical point).

Second Modification

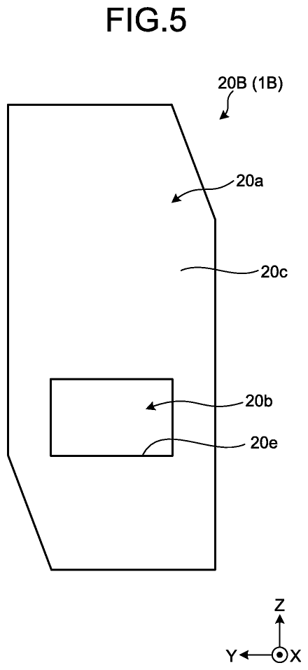

FIG. 5 is a plan view illustrating a prefilter 20B of an electronic apparatus 1B according to the second modification. The electronic apparatus 1B has the same configuration as the electronic apparatus 1 of the above-described embodiment. Thus, the electronic apparatus 1B obtains the same actions and effects based on the same configuration as the above-described embodiment.

However, the second modification is different from the above-described embodiment in the aspect that the prefilter 20B extends along the intake port 21e (see FIGS. 1 and 3), as illustrated in FIG. 5. The size of the prefilter 20B is set to be substantially the same as the size of the intake port 21e, and the substantially whole area of the intake port 21e is covered by the front surface 20c of the prefilter 20.

Therefore, in the second modification, it is possible to further prevent, with the prefilter 20B, dusts contained in air from entering in the housing 2 through the connectors 5 (see FIG. 1) or the like.

Moreover, as illustrated in FIG. 5, the second part 20b is formed in a square shape in the second modification. In the second modification, when the second part 20b collects dusts, the dusts emerge in a square shape along the second part 20b. Note that the shape of the second part 20b is not limited to this example, and may be modified variously.

In an embodiment, it is possible to obtain an electronic apparatus having a new configuration that reduces efforts for filter maintenance operation.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus, comprising:
a housing comprising a first intake port;
a first filter that is disposed on an outer side of the housing and covers the first intake port; and
a second filter comprising a first part coarser than the first filter and that covers the first filter from a side opposite to the first intake port.

2. The electronic apparatus according to claim 1, wherein the second filter is larger in size than a first surface of the first filter, and
the first surface is closer to the second filter.

3. The electronic apparatus according to claim 1, wherein the second filter comprises a second part with a coarseness equivalent to or finer than a coarseness of the first filter.

4. The electronic apparatus according to claim 3, further comprising:
a cover member comprising a second intake port overlapping the first intake port and covers the second filter from a side opposite to the first filter, wherein
the second part is exposed, through the second intake port, to the side opposite to the first filter.

5. The electronic apparatus according to claim 4, wherein the second part has a similar color to at least one of the first part and a second surface of the cover member, and the second surface is on a side opposite to the second filter.
